(19) United States
(12) Patent Application Publication
(10) Pub. No.: US 2021/0266345 A1
(43) Pub. Date: Aug. 26, 2021

(54) USER-REPORTED MALICIOUS MESSAGE EVALUATION USING MACHINE LEARNING

(71) Applicant: ServiceNow, Inc., Santa Clara, CA (US)

(72) Inventors: Xuchang Chen, San Francisco, CA (US); Patrice Tollenaere, San Francisco, CA (US); Deepakeswaran Kolingivadi, Dublin, CA (US); ChitraBharathi Ganapathy, San Jose, CA (US)

(21) Appl. No.: 16/801,755

(22) Filed: Feb. 26, 2020

(51) Int. Cl. H04L 29/06; G06N 20/00

(52) U.S. Cl. CPC H04L 63/1483; G06N 20/00

(57) ABSTRACT

An indication of a message that was identified by a recipient user of the message as being associated with a cybersecurity attack is received. Properties of the message are extracted. The extracted properties of the message are provided as inputs to a machine learning model to determine a likelihood the message is associated with a true cybersecurity attack. The determined likelihood is utilized to handle a security response associated with the message.

### BACKGROUND OF THE INVENTION

Phishing is a cybercrime that involves a fraudulent attempt to obtain sensitive information of a target. For example, an attacker may attempt to obtain sensitive information by sending to the target an e-mail message that directs the target to enter personal information at a fake website that matches the appearance of its legitimate counterpart. Many security analysts devote a substantial portion of their time and energy to handling phishing attacks and reported phishing attempts. For example, security analysts must determine whether e-mails that have been reported as phishing e-mails are indeed malicious. This can be extremely time-consuming for security analysts. Thus, it would be beneficial to develop techniques to handle reported phishing e-mails programmatically and automatically determine whether they are legitimate or malicious.

### BRIEF DESCRIPTION OF THE DRAWINGS

Various embodiments of the invention are disclosed in the following detailed description and the accompanying drawings.

FIG. 1 is a block diagram illustrating an embodiment of a system for handling user-reported cybersecurity incidents.

FIG. 2 is a block diagram illustrating an embodiment of a cybersecurity incident analysis component.

FIG. 3 is a flow chart illustrating an embodiment of a process for handling user-reported cybersecurity incidents.

FIG. 4 is a flow chart illustrating an embodiment of a process for training a machine learning model to recognize phishing e-mails.

FIG. 5 is a flow chart illustrating an embodiment of a process for utilizing a machine learning model to analyze a user-reported phishing e-mail.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Malicious message evaluation is disclosed. An indication of a message that was identified by a recipient user of the message as being associated with a cybersecurity attack is received. Properties of the message are extracted. The extracted properties of the message are provided as inputs to a machine learning model to determine a likelihood the message is associated with a true cybersecurity attack. The determined likelihood is utilized to handle a security response associated with the message. A practical and technological benefit of the techniques disclosed herein is more efficient cybersecurity incident management. As used herein, cybersecurity incidents are also referred to as security incidents. The techniques disclosed herein can be applied to automatically identify user-reported phishing e-mails that are not actually malicious. Reducing the false-positive rate of user-reported phishing e-mails (legitimate e-mails that have been incorrectly reported as malicious) in an automated manner means reducing the amount of work that security analysts must perform to manually determine that e-mails reported as malicious are actually legitimate. Thus, a benefit is that there is a reduction of work for security analysts, which allows security analysts to devote more time and energy to other cybersecurity incident matters.

As described in further detail herein, in various embodiments, a machine learning framework is utilized to triage and prioritize phishing security incidents, resulting in a reduction of the number of false-positive user-reported phishing e-mails that security analysts must handle. In various embodiments, a user-reported phishing e-mail machine learning model is trained using historical data. As described in further detail herein, various features from historical e-mails may be extracted to train the machine learning model. Example features include those associated with the e-mail body, Uniform Resource Locator (URL) addresses, clickable links (e.g., hyperlinks), etc. In various embodiments, feature extraction occurs when a user reports a suspicious e-mail. In various embodiments, the machine learning model outputs a prediction result (e.g., predicting whether the suspicious e-mail is malicious or legitimate). A confidence score may also be produced. In various embodiments, the prediction result is sent to a security analyst. The security analyst can manually or automatically accept the prediction result. The security analyst may also customize a workflow to prioritize phishing incidents according to confidence scores. Different workflows can be based on different ranges of confidence scores.

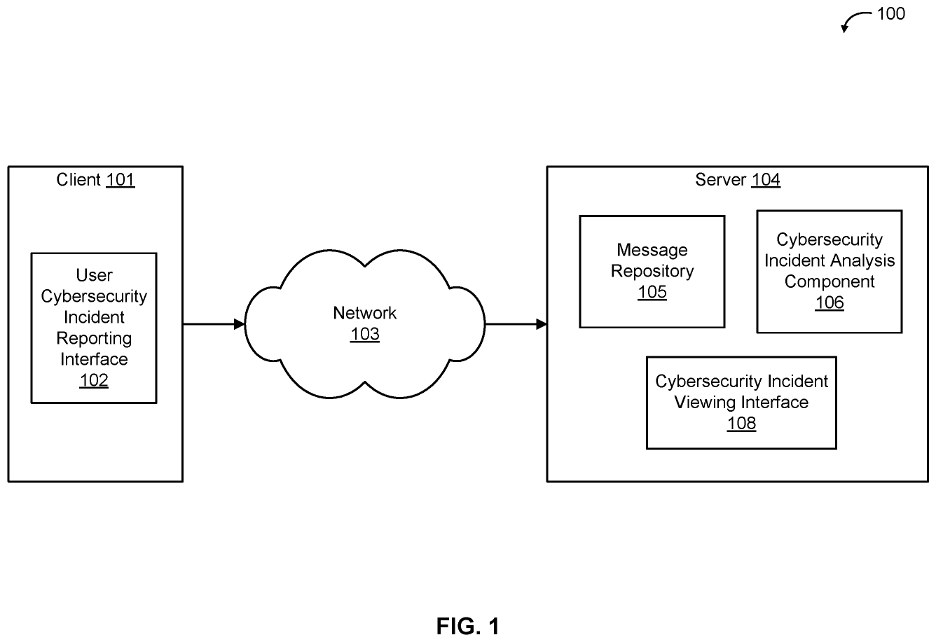

FIG. 1 is a block diagram illustrating an embodiment of a system for handling user-reported cybersecurity incidents. In the example shown, system 100 includes client 101, user cybersecurity incident reporting interface 102, network 103, server 104, message repository 105, cybersecurity incident analysis component 106, and cybersecurity incident viewing interface 108. In some embodiments, client 101 is a computer or other hardware device that a recipient user of messages (e.g., e-mails) utilizes to run applications associated with the messages. For example, e-mail applications may be installed on client 101.

In the example illustrated, user cybersecurity incident reporting interface 101 resides on client 101. In some embodiments, user cybersecurity incident reporting interface 102 is included in an e-mail application. For example, user cybersecurity incident reporting interface 102 may include a component (e.g., a button) within the e-mail application that a recipient user of an e-mail may utilize to report the e-mail as a malicious e-mail (e.g., a phishing attempt). For example, the component may have a label such as “Report Phishing” or a similar label that indicates to the recipient user that utilizing the component will result in the e-mail (e.g., the e-mail the recipient user has highlighted) being reported as a phishing attempt. In various embodiments, user cybersecurity incident reporting interface 102 is utilized by the recipient user of the e-mail to transmit a cybersecurity incident report (e.g., phishing e-mail report) to a security analyst.

In the example illustrated, client 101 is communicatively connected to network 103. A report of a cybersecurity incident (e.g., e-mail phishing attempt) may be transmitted to server 104 using network 103. Examples of network 103 include one or more of the following: a direct or indirect physical communication connection, mobile communication network, Internet, intranet, Local Area Network, Wide Area Network, Storage Area Network, and any other form of connecting two or more systems, components, or storage devices together. In various embodiments, server 104 is a computer or other hardware component that provides cybersecurity incident response functionality. In the example illustrated, message repository 105 resides on server 104. In some embodiments, message repository 105 receives and stores messages indicated by recipient users of the messages to be associated with cybersecurity attacks (e.g., phishing e-mails). Message repository 105 may include a hardware storage component (e.g., a hard drive for message storage).

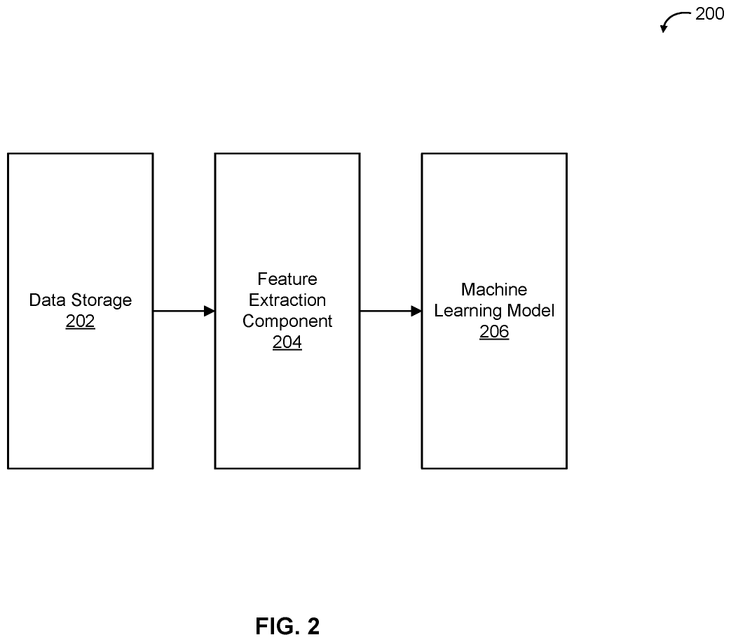

In the example illustrated, cybersecurity incident analysis component 106 resides on server 104. In various embodiments, cybersecurity incident analysis component 106 receives an indication of a message (e.g., e-mail) that was identified as malicious by a recipient user of the message. In various embodiments, cybersecurity incident analysis component 106 extracts properties of the message and analyzes the extracted properties by providing the extracted properties as inputs to a machine learning model to determine a likelihood the message is actually malicious. In some embodiments, cybersecurity incident analysis component 106 extracts properties of messages stored in message repository 105. Further details regarding examples of extracted properties and the machine learning model are described below (e.g., see FIG. 2). As described in further detail herein, the machine learning model may be trained using historical data (e.g., prior malicious and legitimate e-mails that the recipient user or other users have received). In some embodiments, the machine learning model is trained using only historical data associated with the recipient user. Stated alternatively, the machine learning model may be trained on a per user basis. As used herein, user/recipient user can refer to a plurality of users in an organization (e.g., a plurality of employees of an organization, wherein the employees receive e-mail through an e-mail application provided by the organization). It is also possible to aggregate historical data from multiple users/organizations to train the machine learning model.

As described in further detail herein, in some embodiments, the machine learning model is biased toward false-positive predictions (as opposed to false-negative predictions). Stated alternatively, the machine learning model may be biased in the direction of erring more often toward identifying legitimate e-mails as malicious rather than identifying malicious e-mails as legitimate. In various embodiments, cybersecurity incident analysis component 106 outputs a prediction result (e.g., malicious or legitimate) for each user-reported message (e.g., suspicious e-mail). In some embodiments, cybersecurity incident analysis component 106 also outputs a corresponding confidence score indicating a degree of confidence associated with the prediction result. In some embodiments, cybersecurity incident analysis component 106 takes automated action if the confidence score reaches a specified threshold. Examples of automated actions include quarantining the message, disposing the message, isolating a computer (e.g., restricting it from accessing other computers on a network) used to access the message, etc. Cybersecurity incident analysis component 106 may also refer the message to a security analyst for manual processing. For example, if the confidence score does not reach the specified threshold, the corresponding message may be sent to the security analyst for manual verification as to whether it is malicious or legitimate.

In various embodiments, a security analyst utilizes cybersecurity incident viewing interface 108 to view user-reported suspicious messages and/or corresponding predictions results/confidence scores generated by cybersecurity incident analysis component 106. In the example illustrated, cybersecurity incident viewing interface 108 resides on server 104. In some embodiments, cybersecurity incident viewing interfaces resides on another server. Cybersecurity incident viewing interface 108 may be a programmed computer system separate from server 104 and can include a microprocessor, memory (e.g., random-access memory), one or more storage devices, a display component (e.g., a monitor), a keyboard, a pointing device, and a network interface device. Other components may also be present. Various other computer system architectures and configurations can also be used.

In the example shown, portions of the communication path between the components are shown. Other communication paths may exist, and the example of FIG. 1 has been simplified to illustrate the example clearly. Although single instances of components have been shown to simplify the diagram, additional instances of any of the components shown in FIG. 1 may exist. The number of components and the connections shown in FIG. 1 are merely illustrative. The components are not necessarily located in the same geographic location. Components not shown in FIG. 1 may also exist.

FIG. 2 is a block diagram illustrating an embodiment of a cybersecurity incident analysis component. In some embodiments, analysis component 200 is cybersecurity incident analysis component 106 of FIG. 1. In the example illustrated, analysis component 200 includes data storage 202, feature extraction component 204, and machine learning model 206.

In various embodiments, data storage 202 receives and stores a suspicious message such as an e-mail identified as malicious (e.g., a phishing attempt) by a recipient user of the e-mail. In some embodiments, data storage 202 is persistent memory (e.g., a mass storage device) and is coupled either bi-directionally (read/write) or uni-directionally (read only) to feature extraction component 204. Data storage 202 can also include computer-readable media such as magnetic tape, flash memory, PC-CARDS, portable mass storage devices, hard disk drives, holographic storage devices, and other storage devices.

In various embodiments, feature extraction component 204 extracts a set of features from a message (e.g., e-mail) stored in data storage 202. In various embodiments, a script is run to perform extraction of the features. Any of a various number of computer programming languages may be utilized to implement the script. With respect to e-mails, various features may be extracted and utilized to determine whether the e-mails are malicious (e.g., phishing attempts) or legitimate. For example, the e-mail body may be extracted. Phishing e-mails are typically templated and have a specified pattern and can thus be utilized as part of a feature set. In various embodiments, the e-mail body is processed into a text representation. Another feature that may be extracted is the set of URLs in the e-mail. Malicious URLs route targets to a phishing website. In various embodiments, URLs in the e-mail body are extracted, concatenated by commas (‘,’), and saved as text. The number of URLs in the e-mail can also be a feature. Phishing e-mails typically include multiple links to malicious websites. In various embodiments, the total number of links embedded in the e-mail is extracted as an integer. Hostname dot count is another feature that may be extracted. Stated alternatively, the maximum number of dots in a hostname of a URL in the e-mail body can be extracted and represented as an integer. An e-mail in which a hostname has more than three dots may be considered more likely to be malicious.

Other examples of extracted features include features associated with Internet domains. For example, the maximum creation date of domains in the e-mail may be an extracted feature. Stated alternatively, how long domains have been in existence can be a useful feature. The domains of malicious URLs typically do not have a long history; therefore, the maximum creation date of the domains can be a useful feature for determining whether an e-mail is malicious or legitimate. An internet protocol (IP) lookup tool (e.g., Whois) may be used to determine the maximum domain creation date. The maximum domain creation date can be extracted as an integer. The maximum update date of the domains in the e-mail can also be extracted (e.g., using an IP lookup tool such as Whois) as an integer. Stated alternatively, how frequently domains are updated can be a useful feature. The domains of malicious URLs are typically not updated very frequently; therefore, the maximum update date of the domains can be a useful feature. Similarly, the minimum expiration date of the domains in the e-mail can also be extracted as an integer. Stated alternatively, how long domains will persist can be a useful feature. The domains of malicious URLs do not typically last for a long period of time; therefore, the minimum expiration date of the domains can be a useful feature.

Registrars and/or registrants of the domains may also be extracted. Registrars and registrants of the domains (e.g., presence of specified registrars or registrants) are typically indicators of legitimacy. In some embodiments, the registrars of the domains are extracted, concatenated, and represented as text. Similarly, in some embodiments, the registrants of the domains are extracted, concatenated, and represented as text. Another domain-related feature that may be extracted is e-mail body to domain match. Stated alternatively, a comparison of the sender e-mail address domain with the domains in the e-mail body can be performed to determine whether there are any matches between the sender e-mail address domain and any of the e-mail body domains. In some embodiments, a binary representation (e.g., a ‘0’ integer for no matches and a ‘1’ integer for the presence of a match) is used to indicate the absence or presence of an e-mail body to domain match. The absence of any match is typically an indicator that the e-mail is a phishing attempt. Distinct domain count is another feature that may be extracted. Stated alternatively, the number of unique domains from all the URLs in the e-mail body can be counted and extracted as an integer. A higher number of domains can be indicative of a phishing attempt.

The presence an IP address in the e-mail body can be an extracted feature. URLs for many legitimate websites usually contain a descriptive hostname that indicates where the URLs are routing to (e.g., https://www.servicenow.com/, indicating routing to the ServiceNow company website). Phishing e-mails oftentimes attempt to hide the malicious identity of phishing websites by masking the websites with IP addresses (e.g., http://168.77.23.1/paypal/login). Therefore, the presence of an IP address in the e-mail body can be a useful feature for determining whether an e-mail is a phishing attempt. In some embodiments, a binary representation (e.g., a ‘0’ integer for the absence of an IP address and a ‘1’ integer for the presence of an IP address) is used to indicate the absence or presence of an IP address in the e-mail body.

The presence of specified keywords can be extracted features. Stated alternatively, certain words that appear frequently in phishing e-mail can be utilized as features. Examples of these words or word parts include: ‘update’, ‘confirm’, ‘user’, ‘customer’, ‘client’, ‘suspend’, ‘restrict’, ‘hold’, ‘verify’, ‘account’, ‘notif’, ‘login’, ‘username’, ‘password’, ‘click’, ‘log’, ‘ssn’, ‘social security’, ‘secur’, ‘inconvinien’, and others. In some embodiments, a binary representation (e.g., a ‘0’ integer for absence and a ‘1’ integer for presence) is used to indicate the absence or presence of each specified word.

Another feature that can be useful in determining whether an e-mail is a phishing attempt is whether the e-mail is a Hypertext Markup Language (HTML) type e-mail. Stated alternatively, whether a ‘text/html’ attribute exists can be a useful feature. Phishing attacks are oftentimes masked as an HTML type e-mail. In some embodiments, a binary representation (e.g., a ‘0’ integer for absence and a ‘1’ integer for presence) is used to indicate the absence or presence of the ‘text/html’ attribute. Link text is another feature that may be extracted. The presence of words such as ‘link’, ‘click’, ‘here’, etc. in the text of a link is oftentimes present in phishing e-mails to entice targets to click on a link to a malicious website. In some embodiments, a binary representation (e.g., a ‘0’ integer for absence and a ‘1’ integer for presence) is used to indicate the absence or presence of one or more specified words (e.g., ‘link’, ‘click’, ‘here’, etc.) in the link text.

Other e-mail features that can be useful in determining whether an e-mail is a phishing attempt include (but are not limited to) the following: TinyURL count, URL alphanumeric count, sender count, whether the sender domain is included in a specified whitelist of legitimate sender domains, whether the sender domain is included in a specified blacklist associated with malicious data, whether the receiver domain is the same as the sender domain, whether the sender domain is the same as a URL domain, number of URL domains not matching the sender domain, whether a link is to a file share website, whether the sender name includes a first name and/or last name in the e-mail signature, number of receivers of the e-mail, whether the receivers are disclosed (e.g., whether an undisclosed recipients list is used), whether all receiver domains are included in a specified whitelist, whether any receiver domains are included in a specified blacklist, e-mail subject, presence of an attachment, number of attachments, types of attachments, e-mail body length, number of occurrences of the hashtag (′#′) symbol, number of occurrences of the at sign (′@′) symbol, etc.

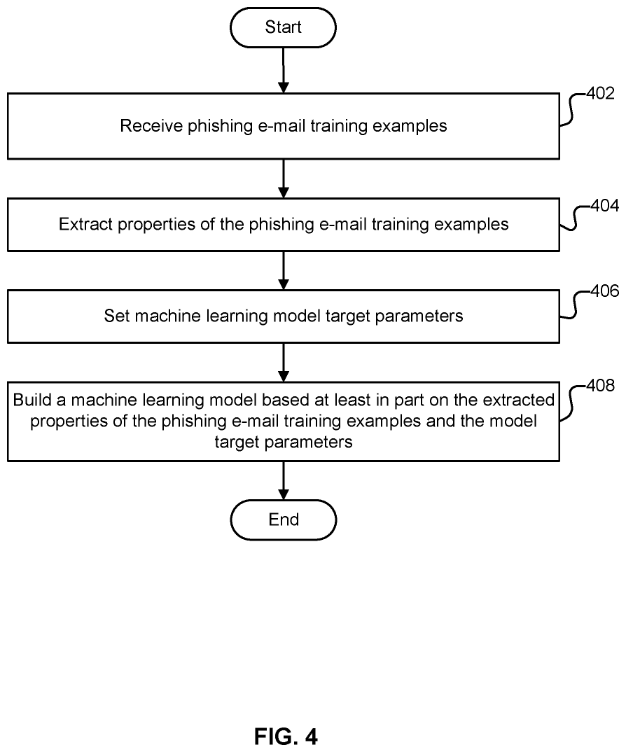

In various embodiments, extracted features from a message (e.g., from an e-mail) are transmitted from feature extraction component 204 to machine learning model 206. Machine learning model 206 utilizes the extracted features to perform classification on the message (e.g., to determine whether the message is malicious (e.g., a phishing attempt) or not). As used herein, the term classification refers to predicting whether a message is malicious or not. In some embodiments, machine learning model 206 is an artificial neural network that is configured to perform a binary classification task. In various embodiments, the artificial network includes an input layer, an output layer, and a plurality of hidden layers. In some embodiments, at least a portion of the layers in the artificial neural network are fully connected. Machine learning model 206 may also be based at least in part on other classification approaches, including but not limited to logistic regression, decision tree, random forest, naive Bayes, nearest neighbor, clustering, principal component analysis, and other approaches. In various embodiments, as described in further detail below (e.g., see FIG. 4), machine learning model 206 is trained using historical message examples. After training is complete, machine learning model 206 can be used in inference mode to predict whether a user-reported message is malicious or legitimate.

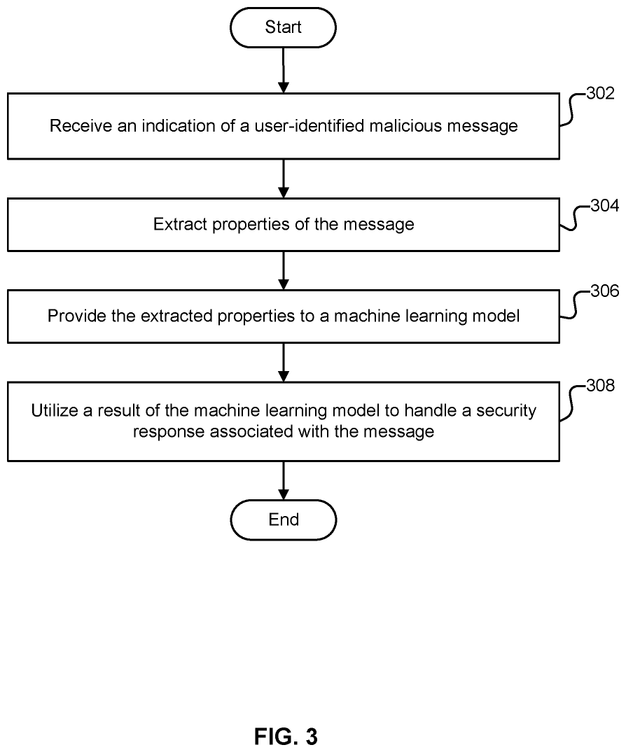

FIG. 3 is a flow chart illustrating an embodiment of a process for handling user-reported cybersecurity incidents. In some embodiments, the process of FIG. 3 is performed by cybersecurity incident analysis component 106 of FIG. 1 and/or analysis component 200 of FIG. 2.

At 302, an indication of a user-identified malicious message is received. In various embodiments, a recipient user of an e-mail identifies the e-mail as malicious (e.g., a phishing attack). In some embodiments, a user reports the message using a cybersecurity incident reporting interface, e.g., user cybersecurity incident reporting interface 102 of FIG. 1. In some embodiments, the indication of the user-identified malicious message is received over a network, e.g., network 103 of FIG. 1. In some embodiments, the user-identified malicious message is received and quarantined so that it can be analyzed safely.

At 304, properties of the message are extracted. The user-identified malicious message includes various features/properties. For example, for e-mail messages, features/properties that may be extracted include those described above with respect to feature extraction component 204 of FIG. 2, e.g., features associated with e-mail body text, domains, URLs, IP addresses, etc. In some embodiments, feature extraction component 204 of FIG. 2 extracts a plurality of features/properties.

At 306, the extracted properties are provided to a machine learning model. In various embodiments, the extracted properties of the message are utilized as inputs by the machine learning model to determine a likelihood that the message is actually malicious. In some embodiments, the machine learning model is machine learning model 206 of FIG. 2. In some embodiments, the machine learning model generates a confidence score indicating the likelihood that the message is actually malicious.

At 308, a result of the machine learning model is utilized to handle a security response associated with the message. For example, the result of the machine learning model may include a confidence score indicating the likelihood that the message is actually malicious. The security response associated with the message can vary depending on the confidence score. For example, if the confidence score reaches a specified threshold corresponding to a high degree of confidence that the message is malicious, then an automated security response (e.g., quarantine, disposal, etc.) may be utilized. If the confidence score does not reach the specified threshold, the security response may include transmitting the message to a security analyst for manual review of the message.

FIG. 4 is a flow chart illustrating an embodiment of a process for training a machine learning model to recognize phishing e-mails. In some embodiments, the process of FIG. 4 is utilized to train machine learning model 206 of FIG. 2.

At 402, phishing e-mail training examples are received. In some embodiments, historical phishing e-mail data is imported. Importing a large amount of historical phishing e-mail data can allow for faster training of the machine learning model so that it can be used sooner in inference mode. It is also possible to wait for a specified amount of training data to be collected (e.g., allow for the accumulation of user-identified phishing e-mails) and then train the machine learning model. In some embodiments, human labeling is utilized to create training data. For example, user-reported phishing e-mails may be analyzed by security analysts to determine which user-reported e-mails are actually malicious and which are legitimate and then labelled appropriately.

At 404, properties of the phishing e-mail training examples are extracted. In various embodiments, the properties are saved into a feature table. In some embodiments, at least some of the properties are the features described above with respect to feature extraction component 204 of FIG. 2. In various embodiments, the extracted properties are used to train a machine learning model. For example, the extracted properties may be used to train an artificial neural network that is configured to perform a binary classification task.

At 406, machine learning model target parameters are set. In some embodiments, the machine learning model is configured to be biased toward classifying user-reported malicious e-mails as malicious, allowing for more phishing e-mails to be detected while also increasing the rate of false-positives (legitimate e-mails being classified as malicious). This bias can be attained by setting machine learning model target parameters. Machine learning model target parameters that can be set include malicious recall, which is the number of e-mails that are classified as malicious divided by the number of malicious e-mails, and work reduction rate, which is the number of legitimate e-mails that are classified as legitimate divided by the total number of e-mails. In many scenarios, the goal of the biased machine learning model is to attain malicious recall of approximately 100% while keeping the work reduction rate at a high percentage. Stated alternatively, when high malicious recall is coupled with a high work reduction rate, malicious e-mails are detected at a high rate while also reducing the amount of effort security analysts spend verifying that legitimate e-mails are indeed legitimate. In various embodiments, targets for malicious recall and word reduction rate are set. For example, a user of the machine learning model may set a 100% target for malicious recall and 60% target for work reduction rate. Stated alternatively, these targets for malicious recall and work reduction rate can be utilized as constraints during construction of the machine learning model.

At 408, a machine learning model is built based at least in part on the extracted properties of the phishing e-mail training examples and the machine learning model target parameters that have been set. For example, an artificial neural network machine learning model may be trained to recognize which extracted e-mail properties of phishing e-mail training examples are associated with which type of e-mails. As part of this training, in various embodiments, a human labels malicious e-mails as malicious and legitimate e-mails as legitimate. In addition, the machine learning model target parameters (e.g., malicious recall and work reduction rate) are added as model constraints. These constraints may be added to an objective function that is being maximized or minimized or a cost function that is being minimized during the training process. Stated alternatively, in various embodiments, a weighted learning mechanism is utilized to train the machine learning model to attain a specified malicious recall while minimizing false positives and maximizing work reduction rate. The cost of a false negative for a phishing e-mail can be initially set according to the inverse of the data distribution of phishing incidents. The training data may be split into two parts: a portion (e.g., 80%) used for building the model and another portion (e.g., 20%) used for validating the model. Time-based splits may be made because phishing is time-sensitive. The validation dataset can be used to adjust the cost of false negatives and to set the probability threshold for predicting an incident as a phishing incident. In various embodiments, the cost matrix and threshold that are determined are recorded and a final model is built based on all the training data.

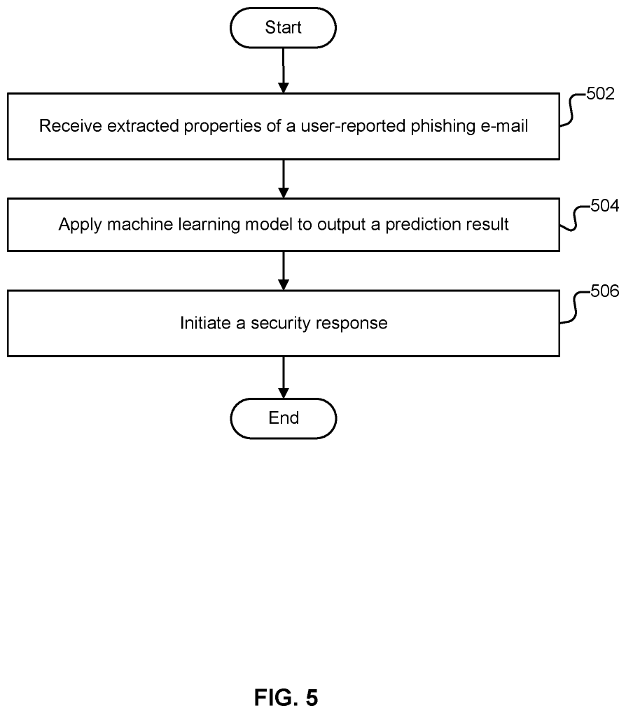

FIG. 5 is a flow chart illustrating an embodiment of a process for utilizing a machine learning model to analyze a user-reported phishing e-mail. In some embodiments, the process of FIG. 5 is performed by machine learning model 206 of FIG. 2. In some embodiments, at least a portion of the process of FIG. 5 is performed in 308 of FIG. 3.

At 502, extracted properties of a user-reported phishing e-mail are received. In some embodiments, at least some of the extracted properties are the features described above with respect to feature extraction component 204 of FIG. 2. In some embodiments, the extracted properties are provided by feature extraction component 204 of FIG. 2. An identifier (e.g., an identifier number) may be associated with the extracted properties to link the extracted properties with the user-reported phishing e-mail. In some embodiments, a security incident (e.g., a data structure associated with the user-reported phishing e-mail) is created to link the extracted properties with the user-reported phishing e-mail and/or to store a transformed version of the user-reported phishing e-mail in which the transformed version is represented based at least in part on the extracted properties.

At 504, a machine learning model is applied to output a prediction result. In various embodiments, the prediction result includes a binary classification result, e.g., whether the user-reported phishing e-mail associated with the extracted properties is predicted to be a phishing e-mail or not. In some embodiments, the prediction result includes a confidence score associated with the binary classification result. For example, a confidence score of 90% associated with a malicious classification result indicates that there is a 90% probability that the user-reported phishing e-mail associated with the extracted properties is malicious. As another example, a confidence score of 60% associated with a legitimate classification result indicates that there is a 60% probability that the user-reported phishing e-mail associated with the extracted properties is legitimate. In some embodiments, the machine learning model is machine learning model 206 of FIG. 2. In various embodiments, the machine learning model is trained using phishing e-mail training examples. In some embodiments, the machine learning model is trained using the process of FIG. 4.

In some scenarios, when applying the machine learning model to a plurality of user-reported phishing e-mails, malicious recall is not 100% or substantially equivalent to 100%. In order to avoid not detecting any malicious e-mails or to detect substantially all malicious e-mails, the machine learning model may be tuned to be more biased towards classifying an e-mail to be malicious. A confidence score threshold can be used to reclassify as malicious user-reported e-mails that are predicted to be legitimate but have a corresponding confidence score lower than a confidence score threshold. For example, this confidence score threshold may be set to 75%, indicating that e-mails initially predicted by the machine learning model to be legitimate with a confidence less than 75% would be reclassified as malicious. Such an approach has a benefit of reducing false negatives (errors in which malicious e-mails are not classified as malicious).

At 506, a security response is initiated. In some embodiments, a security workflow is initiated based on the prediction result, including a confidence score included with the prediction result. For example, if the prediction result is that the user-reported phishing e-mail is indeed malicious and the corresponding confidence score reaches a specified threshold, then an automated workflow may be initiated. In some embodiments, the automated workflow includes isolating a machine (e.g., a computer) that received the user-reported phishing e-mail, firewalling the machine, blocking the user that reported the phishing e-mail from accessing computing resources (e.g., accessing network resources), blocking the e-mail address where the phishing e-mail was received, removing the phishing e-mail from the user's mailbox, deleting the phishing e-mail, quarantining the e-mail, quarantining the user that received the phishing e-mail, and/or other measures. If the prediction result is that the user-reported phishing e-mail is malicious and the corresponding confidence score does not reach the specified threshold, a manual workflow may be initiated. The manual workflow may include measures described above with respect to the automated workflow but initiated by a security analyst. In various scenarios, the manual workflow includes review by the security analyst. In various embodiments, the prediction result, corresponding confidence score, and/or security response measures taken are reported to a security analyst. The security analyst may then determine whether to initiate manual or automatic workflows or customize a workflow (e.g., to prioritize user-reported phishing incidents based on confidence score).

In some scenarios, if the prediction result is that the user-reported phishing e-mail is legitimate and a corresponding confidence score reaches a specified threshold, no security response is initiated and no report is sent to a security analyst. If the confidence score does not reach the specified threshold, a report may be sent to the security analyst in order for the security analyst to determine an appropriate security response. In some scenarios, a report is transmitted to the security analyst regardless of prediction result and confidence score and the security analyst determines the appropriate security response (e.g., ignore e-mails predicted to be legitimate with high confidence, initiate security response workflows for e-mails predicted to be malicious, etc.).

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving an indication of a message that was identified by a recipient user of the message as being associated with a cybersecurity attack;
extracting properties of the message;
providing the extracted properties of the message as inputs to a machine learning model to determine a likelihood the message is associated with a true cybersecurity attack; and
utilizing the determined likelihood to handle a security response associated with the message.

2. The method of claim 1, wherein the cybersecurity attack is a phishing attack.

3. The method of claim 1, wherein utilizing the determined likelihood to handle the security response includes reporting the determined likelihood to a security analyst.

4. The method of claim 1, wherein utilizing the determined likelihood to handle the security response includes initiating an automated security workflow based at least in part on the is determined likelihood.

5. The method of claim 1, wherein utilizing the determined likelihood to handle the security response includes initiating, based at least in part on the determined likelihood, a security workflow that is performed at least in part by a security analyst.

6. The method of claim 1, wherein the security response includes disposal or quarantine of the message.

7. The method of claim 1, wherein the indication is received over a network.

8. The method of claim 1, further comprising storing the message in a storage that is separate from any storage utilized by the recipient user.

9. The method of claim 1, wherein utilizing the determined likelihood includes comparing the determined likelihood to a specified threshold likelihood.

10. The method of claim 1, wherein the machine learning model has been trained using historical messages received by the recipient user or members of an organization to which the recipient user belongs.

11. The method of claim 1, wherein the machine learning model has been trained with a training goal of reaching a specified threshold of correct classification of messages associated with true cybersecurity attacks.

12. The method of claim 1, wherein the machine learning model has been trained with a training goal of reaching a specified threshold of correct classification of legitimate messages.

13. The method of claim 1, wherein the machine learning model is an artificial neural network.

14. The method of claim 1, wherein utilizing the determined likelihood includes initiating a specified security response in response to a determination that the determined likelihood reaches a specified threshold.

15. The method of claim 1, wherein the extracted properties include existences of specified keywords or keyword parts in the message.

16. The method of claim 1, wherein the extracted properties include a count of at least one of the following: Uniform Resource Locators in the message, hyperlinks in the message, or number is of dots in one or more hostnames of Uniform Resource Locators in the message.

17. The method of claim 1, wherein the extracted properties include at least one of the following dates associated with an Internet domain in the message: a creation date, an update date, or an expiration date.

18. The method of claim 1, wherein the extracted properties include whether an Internet protocol address is included in a Uniform Resource Locator in the message.

19. A system, comprising:
a processor configured to:
receive an indication of a message that was identified by a recipient user of the message as being associated with a cybersecurity attack;
extract properties of the message;
provide the extracted properties of the message as inputs to a machine learning model to determine a likelihood the message is associated with a true cybersecurity attack; and
utilize the determined likelihood to handle a security response associated with the message; and
a memory coupled to the processor and configured to provide the processor with instructions.

20. A computer program product, the computer program product being embodied in a non-transitory computer readable storage medium and comprising computer instructions for:
receiving an indication of a message that was identified by a recipient user of the message as being associated with a cybersecurity attack;
extracting properties of the message;
providing the extracted properties of the message as inputs to a machine learning model to determine a likelihood the message is associated with a true cybersecurity attack; and
utilizing the determined likelihood to handle a security response associated with the message.
